(19) United States
(12) Patent Application Publication
(10) Pub. No.: US 2026/0035246 A1
(43) Pub. Date: Feb. 5, 2026

(54) SYSTEM AND METHOD FOR OPTIMIZING PRODUCTION OF ARGON IN A CRYOGENIC AIR SEPARATION UNIT

(71) Applicants: Henry E. Howard, Grand Island, NY (US); Rainer Hoffmann, Taufkirchen (DE)

(72) Inventors: Henry E. Howard, Grand Island, NY (US); Rainer Hoffmann, Taufkirchen (DE)

(21) Appl. No.: 19/091,958

(22) Filed: Mar. 27, 2025

Related U.S. Application Data
(60) Provisional application No. 63/678,167, filed on Aug. 1, 2024.

(51) Int. Cl. C01B 23/00; G01K 11/32

(52) U.S. Cl. CPC C01B 23/0036; G01K 11/32; C01B 2210/0034

(57) ABSTRACT

A system and method of optimizing the production of argon in a cryogenic air separation unit using a temperature profile of a distillation column or distillation column section obtained via fiber optic temperature measurements on the exterior surface of the distillation column or the distillation column section is provided. The temperature profiles are used to determine the vertical location and/or spatial movement of the maximum argon concentration in the distillation column or the distillation column section. Distillation column operation is then adjusted such that the vertical location or spatial movement of the maximum argon concentration is aligned proximate with the location of an argon-rich draw from the distillation column.

### CROSS REFERENCE TO RELATED APPLICATIONS

This application claims the benefit of and priority to United States provisional patent application Ser. No. 63/678,167 filed on Aug. 1, 2024 the disclosure of which is incorporated by reference.

### TECHNICAL FIELD

The present system and method relates to optimizing the production of argon in a cryogenic air separation unit, and more particularly, to using fiber optic temperature measurements of the exterior surface of a distillation column to optimize argon production in an argon producing three column air separation unit.

### BACKGROUND

Increasing or optimizing argon production in a cryogenic air separation unit has traditionally been accomplished by modifying the argon rectification column arrangement. For example, by increasing the number of separation stages in the superstaged or ultra-superstaged argon column, the argon recovery of the air separation unit can be improved. Needless to say, there is additional capital costs associated with adding theoretical stages of separation to the argon column systems of an air separation unit as well as other construction and operational risk issues that arise due to the increased overall height of the argon columns and the associated cold boxes. In many situations, the additional capital costs and operational risks associated with by increasing the number of argon separation stages does not yield a meaningful cost-benefit and in some situations may result in no net cost benefit whatsoever.

Another known means of increasing or optimizing argon production is to position the argon draw from the lower pressure column at a location of maximum argon concentration such that more argon molecules are directed to the argon rectification column. The location of the argon draw on the lower pressure column is typically a design consideration and is usually fixed at time of construction of the distillation column system of an air separation unit. When designing the distillation column system, and in particular the location of the argon side draw from the lower pressure column, care must be taken to avoid or minimize nitrogen contamination in the argon side draw stream. If, in operation of the distillation column system, there is excessive nitrogen included in the argon draw, such nitrogen contamination typically requires shut down of the argon rectification column resulting in a loss of argon product. Such argon dump or loss of argon product due to argon rectification column shut-down can mean loss of revenue up to several hundred thousands of dollars per year per air separation unit.

Avoiding nitrogen contamination or nitrogen breakthrough into the argon rectification column often results in conservative column designs and/or operation of the lower pressure column in a manner that reduces the argon concentration at the argon draw location. What is needed, therefore, is a means to improve or optimize argon production in air separation unit by operating and/or controlling the distillation column system in a manner that ensures the argon side draw stream is taken at the point of maximum argon concentration.

### SUMMARY OF THE INVENTION

The present invention may be characterized as a method of optimizing crude argon production in an argon producing air separation unit, comprising the steps of: (a) receiving a plurality of concurrent temperature measurements from a one or more fiber optic based sensors disposed proximate to an exterior surface of a distillation column or a distillation column section and in a vertical orientation; (b) determining a temperature profile along the vertical length of the distillation column or the distillation column section using the plurality of concurrent temperature measurements from the fiber optic based sensors; (c) ascertaining the vertical location or spatial movement of the maximum argon concentration in the distillation column or the distillation column section using the temperature profile along the vertical length of the distillation column or the distillation column section; and (d) adjusting a flow of one or more streams to the lower pressure column or from the lower pressure column to alter the temperature profile and thereby alter the vertical location or spatial movement of the maximum argon concentration in the distillation column or the distillation column section.

The above-identified steps should be repeated until the vertical location or spatial movement of the maximum argon concentration in the distillation column or the distillation column section is aligned proximate with the location of an argon-rich draw from the distillation column or distillation column section to an argon column of the air separation unit and nitrogen incursion into the argon column is minimized and argon production is optimized. In addition, the step of adjusting the flow of one or more streams preferably comprises adjusting the flow rates of one or more streams selected from the group consisting of a product oxygen stream, a gaseous waste oxygen stream, a crude argon stream, a liquid nitrogen reflux stream, an argon column return stream.

Alternatively, the present invention may be characterized as a fiber optic temperature sensor assembly for an air separation unit, comprising: (i) a plurality of measurement sockets welded to an exterior surface of a distillation column or a distillation column section of the air separation unit and along the vertical length of the distillation column or the distillation column section to define a plurality of temperature measurement points; (ii) one or more fiber optic cables disposed in one or more stainless steel capillary tubes extending through the plurality of measurement sockets, wherein the fiber optic cables comprise one or more fiber optic sensors having a plurality of FBG sensor arrays; and (iii) an FBG interrogator connected to the fiber optic cables and configured for receiving data from the FBG sensor arrays and determining a temperature profile along the vertical length of the distillation column or the distillation column section. The plurality of FBG sensor arrays are preferably disposed in the plurality of measurement sockets and thus exposed to the exterior surface of the distillation column or the distillation column section at the temperature measurement points.

In the preferred embodiments, the distillation column section is an argon section in a lower pressure column of the air separation unit. Alternatively, the distillation column may be a divided wall column of the air separation unit, such as an annular divided wall arrangement, where the fiber optic based sensors may be disposed within a lower pressure column shell adjacent to an argon rectification column section.

In many of the embodiments the one or more fiber optic based sensors are fiber Bragg grating (FBG) sensor arrays configured for use at temperatures in a range of about −150° C. and −200° C. and where the spatial density of the fiber Bragg (FBG) sensor arrays is preferably greater than or equal to 2.0 per vertical linear meter of the exterior surface of the distillation column or the distillation column section. For optimal control purposes, the ideal spatial density of the fiber Bragg grating (FBG) sensor arrays is at least one measurement point per Height Equivalent to a Theoretical Plate (HETP) of the distillation column.

### BRIEF DESCRIPTION OF DRAWINGS

It is believed that the claimed invention will be better understood when taken in connection with the accompanying drawings in which:

FIG. 1 shows a graph that depicts a typical lower pressure column temperature profile and nitrogen concentration profile as a function of vertical position of the lower pressure column (as characterized by separation stages from the bottom of the column);

FIG. 2 is a general illustration showing the placement of the fiber optic temperature sensor assemblies on the exterior surface of a distillation column or distillation column section in accordance with an embodiment of the present system and method; and

FIG. 3 shows a cross section view of a measurement socket and fiber optic cables disposed in stainless steel capillary tubes extending through the measurement socket.

### DETAILED DESCRIPTION

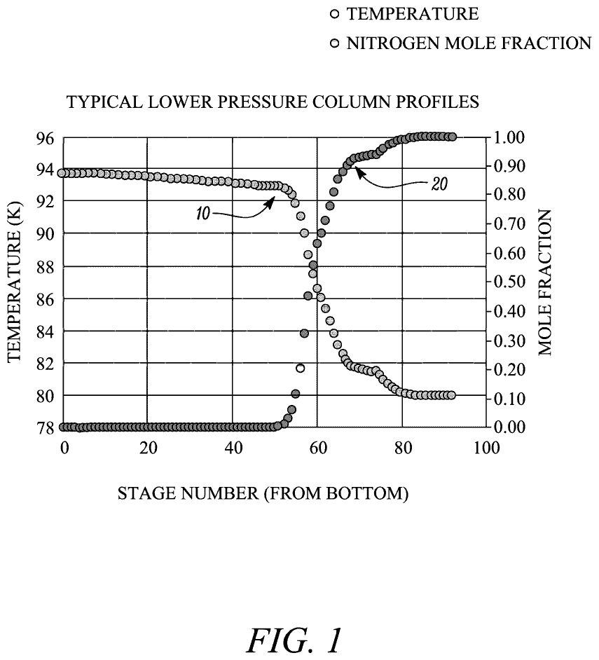

Turning to FIG. 1, the depicted graph shows a typical lower pressure column temperature profile 10 and nitrogen concentration profile 20 as a function of vertical position within of the lower pressure column. The graph illustrates the critical region where the temperature within the lower pressure column and the nitrogen concentration within the lower pressure column rapidly changes. This section of the lower pressure column is often referred to as the ‘argon section’ of the distillation column and is typically the section or region defined roughly by separation stages 50 through 70 as sequentially counted from the bottom of the lower pressure column in an air separation unit. The change in nitrogen concentration (expressed as molar fraction) in this section or region is often characterized as the ‘nitrogen front’ that occurs within the lower pressure column in an air separation unit.

In conventional air separation unit designs, in order to minimize or avoid nitrogen contamination in the argon draw taken from the lower pressure column, the distillation column design often locates the argon draw at a vertical position that is NOT the maximum argon concentration, but rather at a lower position or lower stage where the nitrogen content is known to be very low. Also to avoid unnecessary capital costs and complexities of installation, many conventional air separation units are constrained to take temperature measurements using discrete Resistance Temperature Detectors (RTDs) at only 3 or 4 fixed points along the distillation column sections of the lower pressure column, as it is commonly known that lower pressure column temperatures are sensitive to composition as generally shown in FIG. 1.

One such location of discrete RTD temperature measurement is often at or near the argon draw location and that single point RTD temperature measurement is routinely used in supervisory control systems of the air separation unit in an attempt to minimize nitrogen excursions into crude argon feed stream. However, a single temperature measurement point still has drawbacks from an operation and control standpoint of the distillation column system as there are many operational variables and conditions that impact the accuracy and responsiveness of the RTD and the ability to minimize nitrogen excursions into crude argon feed stream. In addition, use of discrete RTDs are more intrusive to the distillation column and involve additional cost and labor to install and commission.

Other disadvantages of the conventional single temperature measurement point solution (i.e. single discrete RTD temperature measurement at or near the argon draw location) is that the air separation plant control setup and temperature setpoints are typically defined at time of air separation plant commissioning and only for the distillation column design case or scenario. So if the distillation column and/or air separation plant later operates in different operating conditions, such as part-load conditions, the initial control settings and temperature setpoints are often far off from an optimal setpoint at those different or non-standard operating conditions Also, any measurement uncertainty realized during initial setup of the single temperature measurement solution during plant commissioning will remain in the operational control of the distillation column. For this reason, when using the conventional single temperature measurement point solution, the control setup and temperature setpoints often adopt unnecessarily conservative settings to mitigate the uncertainties and avoid nitrogen incursion into the argon column during plant operations.

What is proposed is the use of a temperature profile of a distillation column or distillation column section obtained via fiber optic temperature measurements on the exterior surface of the distillation column or the distillation column section in lieu of a single discrete RTD temperature measurement at or near the argon draw location.

By using more temperature measurements along the vertical length of a distillation column or distillation column section, and more preferably a temperature profile as a function of vertical position, more data points are available to detect movement of the nitrogen front and/or movement of the location of the maximum argon concentration more quickly and more accurately and then adjust the operational control of the distillation column system to align the location of the maximum argon concentration with the location of the argon draw. Moreover, temperature measurements on the exterior surface of the distillation column greatly reduces the cost and complexity of temperature sensor installation and commissioning.

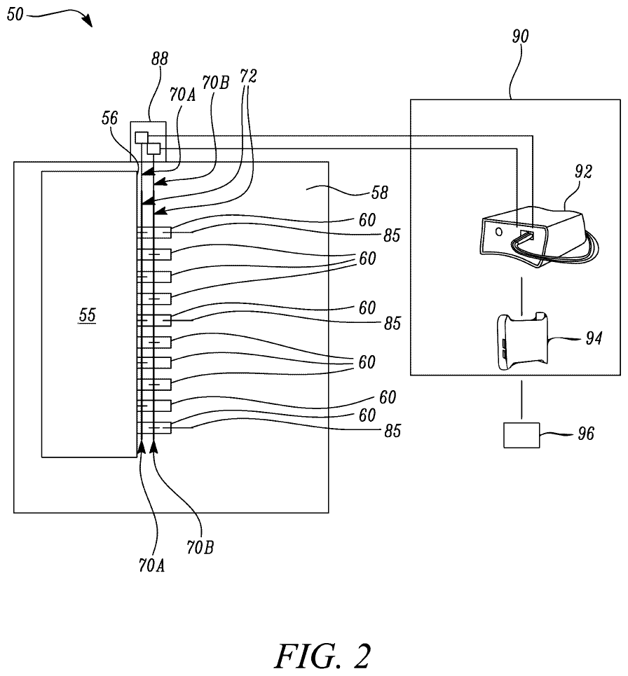

Turning to FIG. 2, there is shown an illustration of the fiber optic temperature sensor assemblies disposed on the exterior surface of a distillation column 55 or distillation column section in accordance with an embodiment of the present system and method. As seen therein, a plurality of aluminum measurement sockets 60 are welded to an exterior surface 56 of a distillation column 55 or a distillation column section within a cold box 58 of the air separation unit to ensure thermal contact. The measurement sockets 60 are placed along the vertical length of the distillation column 55 or the distillation column section and defines a plurality of exterior temperature measurement points. While it is understood that the temperatures at the exterior surface of the distillation column or distillation column section is not equal to the temperature inside the column, the data collected from the exterior temperature measurement points are useful to define a temperature profile occurring inside the column using algorithms developed using extrinsic data correlating interior temperatures to exterior surface temperatures. Even without the correlation algorithms, the temperature profiles on the exterior surface 56 of the distillation column 55 or distillation column section can still be very useful for operational control of the distillation column system, and more particularly for control of the nitrogen front or the location of maximum argon concentration.

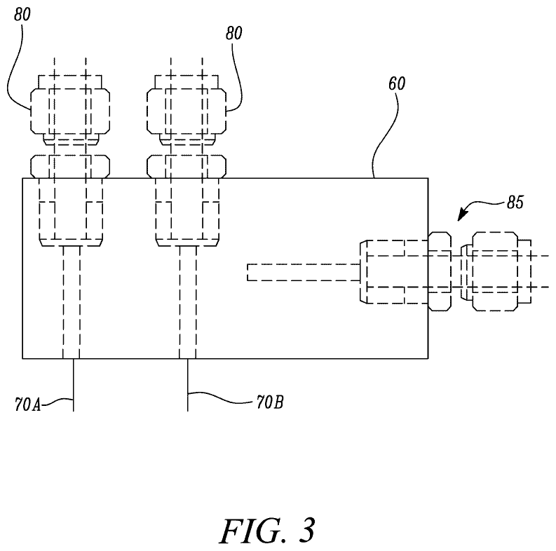

The fiber optic temperature sensor assemblies 50 shown in FIG. 2 and FIG. 3 also includes a pair of fiber optic cables 70A, 70B disposed in stainless steel capillary tubes 72 and extending through a plurality of measurement sockets 60. In the illustrated embodiment, a first fiber optic cable 70A extends through roughly half of the measurement sockets 60 while a second fiber optic cable 70B extends through roughly the other half of the measurement sockets 60, preferably in an alternating arrangement with the first fiber optic cable 70A. In other words, the first fiber optic cable 70A may be operatively connected to the first, third, fifth, seventh, ninth, etc. measurement sockets while the second fiber optic cable 70B may be operatively connected to the second, fourth, sixth, eighth, tenth, etc. measurement sockets. The fiber optic cables 70A, 70B are operatively connected to their respective measurement sockets 60 via a feedthrough 80 as illustrated in FIG. 3. Also, additional RTD sensors 85 may also be optionally disposed in a handful of the measurement sockets 60 to provide complementary data for reference, correlation and/or calibration purposes.

The fiber optic cables 70A, 70B preferably comprise one or more fiber optic sensors having a plurality of FBG sensor arrays that are disposed in the plurality of measurement sockets 60 and thus exposed to the exterior surface of the distillation column 55 or the distillation column section at the temperature measurement points. The FBG sensor arrays are preferably configured for use at temperatures in a range of about 50° C. and −265° C., and more preferably in a temperature range of about. −150° C. and −200° C. The fiber optic temperature sensor assembly each preferably configured with 10 or more temperature measurement arrays, and more preferably between 10 and 30 temperature measurement arrays per fiber optic cable. The spatial density of the fiber Bragg grating (FBG) sensor arrays is preferably greater than or equal to 2.0 FBG sensor arrays per vertical linear meter along the exterior surface of the distillation column or the distillation column section, and more preferably a spatial density of at least one temperature measurement arrays per Height Equivalent to a Theoretical Plate (HETP) of the distillation column.

The fiber optic cables 70A, 70B are connected to a junction box 88 preferably disposed outside the cold box containing the distillation column, From the junction box 88, the data signals from the fiber optic cables are directed to an FBG interrogator 92 disposed in the Instrument Rack Room 90 configured for receiving the data from the FBG sensor arrays and determining a temperature profile along the vertical length of the distillation column or the distillation column section. The FBG interrogator 92 is preferably connected to the data control system 96 for the air separation unit via a digital data connection device 94 such as a Modbus based data connection device.

The fiber optic temperature sensor assembly with the plurality of temperature sensors described above is used to collect a plurality of concurrent temperature measurements and produce a temperature profile along the vertical length of the distillation column or the distillation column section using the temperature measurements from the fiber optic based sensors. Analyzing the temperature profile over time, one can ascertain the approximate vertical location and/or spatial movement of the ‘nitrogen front’ as well as the location of the maximum argon concentration in the distillation column or the distillation column section.

Knowing the location of the ‘nitrogen front’ and/or the location of the maximum argon concentration in the distillation column or the distillation column section, one can adjust various column operating parameters which would impact the temperature profile and move the nitrogen front such that the location of the maximum argon concentration is generally aligned with the location of the argon side draw.

Examples of the column operating parameters that can be adjusted to impact the temperature profile and move the nitrogen front in the distillation column may include: (i) adjustments to the product oxygen flow rate; (ii) adjustments to the gaseous waste oxygen flow rate; (iii) adjustments to the crude argon feed flow rate; and (iv) adjustments to the liquid nitrogen reflux and/or argon column return streams to the lower pressure column. In short, adjusting flow rates of streams to or from the lower pressure column would likely impact the location of the nitrogen front and/or location of the maximum argon concentration in the distillation column. Alternative control levers are also contemplated depending on the configuration of the air separation unit, including for example adjustments to the flow of condensing medium (e.g. liquid air, liquid oxygen, kettle liquid, or a synthetic kettle stream) to the argon condenser or even adjustments to flows from the higher pressure column to intermediate pressure columns. It is understood that in making any of the adjustments to the column operating parameters described herein, the response time until a noticeable change in the nitrogen front occurs may be about 15 minutes or more

While he present systems and methods have been described with reference to several preferred embodiments, it is understood that numerous additions, changes, and omissions can be made without departing from the spirit and scope of the present inventions as set forth in the appended claims.

What is claimed is:

1. A method of optimizing crude argon production in an argon producing air separation unit, comprising the steps of:
(a) receiving a plurality of concurrent temperature measurements from a one or more fiber optic based sensors disposed proximate to an exterior surface of a distillation column or a distillation column section and in a vertical orientation;
(b) determining a temperature profile along the vertical length of the distillation column or the distillation column section using the plurality of concurrent temperature measurements from the fiber optic based sensors;
(c) ascertaining the vertical location or spatial movement of the maximum argon concentration in the distillation column or the distillation column section using the temperature profile along the vertical length of the distillation column or the distillation column section;
(d) adjusting a flow of one or more streams to the lower pressure column or from the lower pressure column to alter the temperature profile and thereby alter the vertical location or spatial movement of the maximum argon concentration in the distillation column or the distillation column section; and
(e) repeating steps (a) through (d) until the vertical location or spatial movement of the maximum argon concentration in the distillation column or the distillation column section is aligned proximate with the location of an argon-rich draw from the distillation column or distillation column section to an argon column of the air separation unit and nitrogen incursion into the argon column is minimized and argon production is optimized.

2. The method of claim 1, wherein the distillation column section is an argon section in a lower pressure column of the air separation unit.

3. The method of claim 2, wherein the location of the maximum argon concentration is the location where nitrogen content in the argon section expressed in mole fraction is in a range of about 0.008 and 0.010.

4. The method of claim 1, wherein the distillation column is a divided wall column of the air separation unit and the fiber optic based sensors are disposed within a lower pressure column section adjacent to an argon rectification column section.

5. The method of claim 4, wherein the location of the maximum argon concentration is the location where nitrogen content expressed in mole fraction is in a range of about 0.008 and 0.010.

6. The method of claim 1, wherein the one or more fiber optic based sensors are fiber Bragg grating (FBG) sensor arrays configured for use at temperatures in a range of about −150° C. and −200° C.

7. The method of claim 6, wherein the spatial density of the fiber Bragg grating (FBG) sensor arrays is greater than or equal to 2.0 per vertical linear meter of the exterior surface of the distillation column or the distillation column section.

8. The method of claim 1, wherein the one or more fiber optic based sensors further comprise two parallel fiber Bragg grating (FBG) sensor arrays each configured with 10 or more measurement points that are each coupled to the exterior surface of the distillation column or the distillation column section.

9. The method of claim 8, wherein the spatial density of the fiber Bragg grating (FBG) sensor arrays is at least one measurement point per Height Equivalent to a Theoretical Plate (HETP) of the distillation column.

10. The method of claim 1, wherein the step of adjusting the flow of one or more streams further comprises adjusting the flow rates of one or more streams selected from the group consisting of a product oxygen stream, a gaseous waste oxygen stream, a crude argon stream, a liquid nitrogen reflux stream, an argon column return stream.

11. A fiber optic temperature sensor assembly for an air separation unit comprising:
a plurality of measurement sockets welded to an exterior surface of a distillation column or a distillation column section of the air separation unit and along the vertical length of the distillation column or the distillation column section to define a plurality of temperature measurement points;
one or more fiber optic cables disposed in one or more stainless steel capillary tubes extending through the plurality of measurement sockets;
wherein the fiber optic cables comprise one or more fiber optic sensors having a plurality of FBG sensor arrays;
wherein the plurality of FBG sensor arrays are disposed in the plurality of measurement sockets and exposed to the exterior surface of the distillation column or the distillation column section at the temperature measurement points; and
an FBG interrogator connected to the fiber optic cables and configured for receiving data from the FBG sensor arrays and determining a temperature profile along the vertical length of the distillation column or the distillation column section.

12. The fiber optic temperature sensor assembly of claim 11, wherein the distillation column section is an argon section in a lower pressure column of the air separation unit.

13. The fiber optic temperature sensor assembly of claim 11, wherein the distillation column is a divided wall column of the air separation unit and the fiber optic based sensor assembly is disposed within a lower pressure column section adjacent to an argon rectification column section of the divided wall column.

14. The fiber optic temperature sensor assembly of claim 11, wherein the fiber Bragg grating (FBG) sensor arrays are configured for use at temperatures in a range of −150° C. and −200° C.

15. The fiber optic temperature sensor assembly of claim 11, wherein the fiber Bragg grating (FBG) sensor arrays have a spatial density greater than or equal to 2.0 per vertical linear meter of the exterior surface of the distillation column or the distillation column section.

16. The fiber optic temperature sensor assembly of claim 11, wherein the one or more fiber optic sensors having a plurality of FBG sensor arrays further comprise at least two parallel fiber Bragg grating (FBG) sensor arrays each configured with 10 or more measurement points.

17. The fiber optic temperature sensor assembly of claim 16, wherein the fiber Bragg grating (FBG) sensor arrays have a spatial density along the exterior surface of the distillation column of at least one measurement point per Height Equivalent to a Theoretical Plate (HETP) of the distillation column.
